(19) United States
(12) Patent Application Publication
(10) Pub. No.: US 2018/0039927 A1
(43) Pub. Date: Feb. 8, 2018

(54) AUTOMATIC SUMMARIZATION OF EMPLOYEE PERFORMANCE

(71) Applicant: General Electric Company, Schenectady, NY (US)

(72) Inventors: Abhay HARPALE, San Ramon, CA (US); James JOBIN, San Ramon, CA (US); Shiva Prasad KASIVISWANATHAN, Dublin, CA (US); Anuj TEWARI, San Ramon, CA (US)

(21) Appl. No.: 15/229,721

(22) Filed: Aug. 5, 2016

(51) Int. Cl. G06Q 10/06; G06F 17/30

(52) U.S. Cl. CPC G06Q 10/06398; G06F 17/30705

(57) ABSTRACT

A system, medium, and method including receiving input data relating to an employee, the input data including a plurality of sentences of descriptive language regarding the employee's performance; processing the input data to determine sentences of refined textual data; determining a category for each of the sentences of the refined textual data from a plurality of categories, each of the plurality of categories being different from each other and relating to a particular type of performance evaluation characteristic; generating, based on the refined textual data and the determined category for the sentences of the refined textual data, a plurality of summary sentences reflective of the input data; and generating a summarization of the employee's performance, the summarization including an ordered listing of the plurality of summary sentences.

### BACKGROUND

Employee reviews, also sometimes referred to as employee performance evaluations or appraisals, are used by a large number of institutions, both private and public, to evaluate how well (or not so well) workers are performing relative to their work responsibilities. In general, the employee's performance process is intended to document and evaluate the employee's performance. In some instances, an employee performance evaluation may be part of a career development process for the employee being evaluated and might include periodic reviews of the employee's performance within the organization.

While employee performance evaluations might be intended to assess an individual employee's job performance and productivity in relation to some established criteria and objectives, to the benefit of both the individual employee and the organization, the process may be fraught with anxiety by both the individual employee being evaluated and the manager(s) or other entity within the organization evaluating the employee. Traditionally, employees might, towards the end of the year, provide a listing of their accomplishments, contributions, strengths, and weaknesses into a (centralized) employee performance system, wherein the employee's comments and descriptions of themselves would be reviewed by a manager, supervisor, or other entity as part of an annual review. As such, the accuracy of the employee's input to the employee performance review system might be critical to the review and evaluation of the employee's manager or supervisor.

In general, prior employee performance evaluation systems and models tend to rely on the employee's self-described characterizations of their performance. Such descriptions may be vague, overly complimentary, or somehow otherwise biased. The potential to be susceptible to biases and other influences may contribute to an employee performance evaluation or review that is not reflective of the employee's true performance and/or require additional dialogue between an individual employee and their manager or supervisor during the review process.

### BRIEF DESCRIPTION OF THE DRAWINGS

FIG. 1 is an example embodiment block diagram of a system;

FIG. 2 is an example embodiment of a logical configuration of an automatic summarization pipeline;

FIG. 3 is an illustrative flow diagram of a process, according to some embodiments; and

FIG. 4 is a block diagram of an apparatus, according to some embodiments.

### DETAILED DESCRIPTION

The following description is provided to enable any person in the art to make and use the described embodiments. Various modifications, however, will remain readily apparent to those in the art.

In some aspects of the present disclosure, one embodiment includes a method of employee evaluation that includes continuous employment development via employee performance related inputs provided over a given period of time to automatically generate a summarization of the employee's performance during the subject period of time. In some embodiments, the period of time may be a calendar year or divisions thereof. In some instances, the period of time may correspond to the period of review for a particular employee's performance review, including divisions or multiples thereof. In some embodiments, the summarization may be automatically generated at the end of the period of time, continuously updated as input data is received, periodically updated at specified or predetermined instances, and combinations thereof.

Some embodiments of the present disclosure include a model or framework that may provide, facilitate, or generate a summarization of an employee's (or other entity) performance.

In the context and application of employee performance review and/or evaluation, input data may be formatted as textual data. The textual data may include, alone and in combination, structured data, unstructured data, and semi-structured data. The textual data may be represented by various data structures, including currently known and future developed file formats that might be generated, stored, and transmitted electronically between different types of devices (e.g. a smartphone, a tablet, and a laptop computer), systems (e.g., a database management system, etc.), services (e.g., a cloud-based employee performance evaluation service), and components (e.g., hard drives, etc.).

As used herein within the context and application of employee performance review and/or evaluation, textual data includes data related to or descriptive of an employee's performance including one or more words. In some instances, the one or more words may form a sentence, a sentence fragment, a phrase, or simply a word. Herein, sentence may include one or more words, including a string of words arranged in an order understandable by a human and a device capable of understanding text as a human might. Herein, a sentence including one or more words may be represented in any format, state, data structure, and file/record configuration, unless otherwise stated. In some embodiments herein, the textual input may be expressed as text-based sentences including one or more words of text arranged in a language understandable by humans (e.g., English, French, Chinese, etc.). Representations of the sentences may be stored in one or more different formats, states, data structures, and file configurations, while being outwardly presented to a user in the form of a textual (i.e., alpha-numeric) sentences.

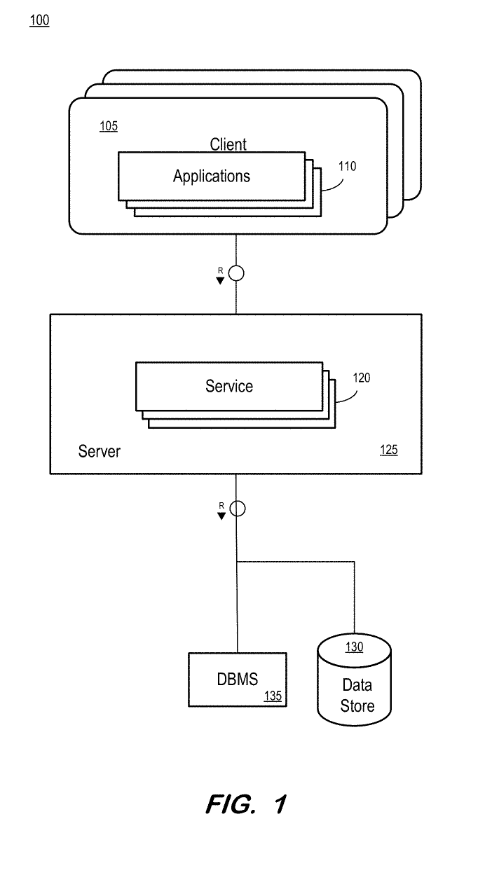

FIG. 1 is an illustrative block diagram of an architecture or system 100, in one example. System 100 includes one or more client devices 105 running an application 110. Examples of some embodiments of the present disclosure are not limited to the particular architecture 100 shown in FIG. 1.

System 100 includes a service 120 that executes within server 125. Service 120 can receive requests for a service from clients 105 executing applications 110 and reply with responses or results sent to applications 110 based on data stored within data store 130 that is further managed by database management system (DBMS) 135.

Server 125 may include server-side executable instructions (e.g., program instructions such as, for example, compiled code, scripts, etc.) that can provide functionality to applications 110 by providing user interfaces to clients 105, receiving requests from applications 110, retrieving data from data store 130 based on the requests, processing the data received from data store 130 by DBMS 135, storing some of the processed data on data store 130, providing the processed data to applications 110. Services 120 may be made available for execution by server 125 via registration and/or other security and login procedures, which may be known in the art.

In one specific example, a client 105 executes an application 110 to present a user interface related to an employee performance summarization service or application to a user on a display of client 105. The user (e.g., an employee, an employee's supervisor, or another entity having, for example, knowledge of the employee's responsibilities and performance or execution of jobs/tasks related to those responsibilities) enters one or more text sentences regarding a particular employee's work-related performance into the user interface of the application. Application 110 operates to send or transmit the text sentences to service 120. In some instances, the text sentences might be processed by service 120 in accordance with one or more processes disclosed herein (at least portions thereof) and results of the that processing can be forwarded to DBMS 135. The DBMS may execute instructions to manage and generate employee performance summarization reports in reply to the request. Thereafter, the employee performance summarization reports can be used by employees, managers, and other entities in periodically evaluating an employee's performance.

Server 125 may provide suitable protocol interfaces through which applications 110 executing on clients 105 may communicate with services 120 executing on application server 125. For example, server 125 may include a HyperText Transfer Protocol (HTTP) interface supporting a transient request/response protocol over Transmission Control Protocol (TCP), and/or a WebSocket interface supporting non-transient full-duplex communications between server 125 and any clients 105 that implement the WebSocket protocol over a single TCP connection.

Data store 130 may comprise any data source or sources that are or become known. Data store 130 may comprise a relational database, a HTML document, an eXtendable Markup Language (XML) document, or any other data storage system storing structured and/or unstructured data files including textual data. The data of data store 130 may be distributed among several data sources. Embodiments are not limited to any number or types of data sources.

Data store 130 may implement an “in-memory” database, where a full database stored in volatile (e.g., non-disk-based) memory (e.g., Random Access Memory). The full database may be persisted in and/or backed up to fixed disks (not shown). Embodiments herein are not limited to an in-memory implementation. For example, data may be stored in Random Access Memory (e.g., cache memory for storing recently-used data) and other forms of solid state memory and/or one or more fixed disks (e.g., persistent memory for storing their respective portions of the full database).

Each of clients 105 may include one or more devices executing program instructions of an application 110 for presenting user interfaces to allow user interaction with application server 125. User interfaces (not shown in FIG. 1) of applications 110 may comprise user interfaces suited to any interface function based on the data of data store 130. In some embodiments, a user may enter text-based inputs into a user interface of their client device 105. In some instances, the user may enter one or more words (i.e., sentences) in reply to a solicitation for information from the application. The text can be, in some embodiments, any combination of words chosen by the user to describe an employee's performance from, for example, the user's perspective and/or knowledge. In some embodiments, the length of the user's entries may be limited to a specific word count, format, or one of a range of words (e.g., “exceed expectations”, “met expectations”, “below expectations”, “not applicable”, etc.) or numbers (e.g., in reply to the request to “select a number on a scale of 1-5 that reflects the employee's performance, where 1 is totally unsatisfactory and 5 is highly satisfactory”).

Although embodiments have been described with respect to certain contexts, some embodiments may be associated with other types of devices, systems, and configurations, either in part or whole, without any loss of generality.

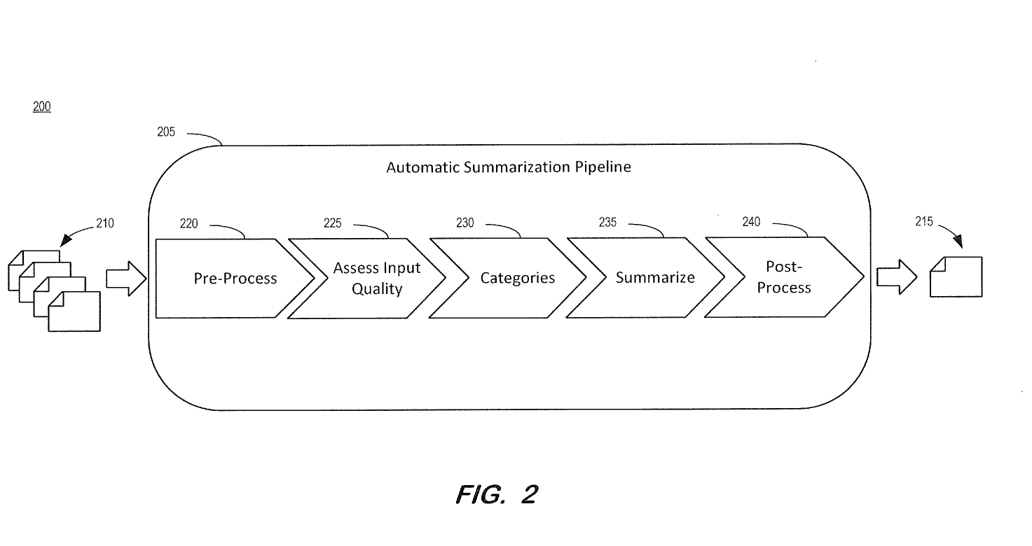

FIG. 2 is an illustration of a logical pipeline 200 for an example embodiment herein. FIG. 2 includes an automatic summarization pipeline 205 whose technical effect is to receive inputs 210 and generate an output 215 based on a number of processes 220-240. In some embodiments, in the context of an employee performance evaluation use-case, inputs 210 may include, but need not be limited to, text-based data from one or more entities providing their articulated thoughts, evaluations, impressions, priorities, insights, touch points, accomplishments, contributions, and ratings regarding an employee's performance relative to one or more specific tasks, jobs, responsibilities or the employee's general performance. The generated output 215 may include a summarization of the inputs, where the summarization is automatically performed by pipeline 205 in response to receiving the inputs 210. That is, in some embodiments a system, apparatus, application, or service may automatically generate a summarization report or output 215 based on inputs 205, without user intervention or manipulation.

In some aspects, employees and other entities may generate and enter input into automatic summarization pipeline (also referred to simply as “pipeline”) 205 over a period of time. The period of time may be a year or 12-month period coinciding with a yearly performance review period of one year (e.g., a “yearly” review). In some embodiments, users may enter text and other types of data relating to an employee (e.g., employee performance) throughout an evaluation period such a one calendar year in the present example. In some use-cases, an organization running or executing a system or process implementing pipeline 205 may encourage or require users to enter statements related to an employee's performance into pipeline 205 throughout the year. As such, there may (and in some instances should) be a plurality of data inputs 210 provided to pipeline 205.

In some embodiments, pipeline 205 may be logically visualized as comprising a plurality of functional or execution modules 220-240, where each execution module can perform one or more functions or tasks. In some embodiments, each execution module may be implemented by a distinct system, application, service or component, all of the execution modules may be implemented by a same system, service, application, or component; and in some embodiments two or more of the execution modules may be implemented by a same system, service, application, or component. In some embodiments, one or more of the functions performed by execution modules 220-240 may be combined into one or more operations or execution threads, while in some other embodiments one or more of the functions performed by execution modules 220-240 may be distributed amongst one or more operations or execution threads.

In some aspects, the inputs 210 may relate to a particular type of performance characteristic. In one example, there may be three different types of performance characteristics used in an example embodiment. For example, a system or process may include three types of performance characteristics. In this one example, the types of performance characteristics may include priorities, touch points, and insights. Priorities may include an ordered listing or prioritized listing of an employee's responsible tasks or areas of responsibility. Herein, a touch point may refer to instance or times that an entity (e.g., manager and other stakeholders) had a discussion or other contact or interaction with a subject employee. Insights herein may refer to statements of observation or guidance that an entity (e.g., manager and other stakeholders) may provide or otherwise communicate to provide to an employee (e.g., comments to improve work to be done and commendations regarding work already done, etc.).

Regarding pipeline 205, the pipeline may operate to consider, review, “look at”, or otherwise process all of the user-generated text content included in input 210 in an effort or process to, for example, reduce the inputs 210 to a length limited set of textual representations (e.g., sentences). In some instances, the set may be a paragraph and the length may be limited to 250 (or some other quantity) words. In general, pipeline 205 may process the input (e.g., sentences) to determine the employee performance relevant sentences, accomplishments, contributions, as well as strengths and weaknesses/strengths, if any. The output of pipeline 205 may include a summarization of the employee performance related inputs 210.

Execution module 220 may operate to pre-process or (pre)condition the inputs so that the inputs (i.e., data 210) are configured for further processes by pipeline 205. The preprocessing may include, for example, translating the text inputs into a common language, formatting the text to a predetermined formatting, and other considerations. In some embodiments, input data 210 may include metadata relating to an employee and the pre-processing may include extracting the metadata from the input data and/or formatting it to a particular configuration to use it in one or more other operations of the automatic summarization process. In some embodiments, operation 305 may be executed automatically in response to a receipt of data input.

At module 225, a determination is made to evaluate the quality of the inputs 210. The inputs, having been pre-processed, may be reviewed and compared to a catalog, baseline, or other set of data to ascertain a relative (as compared to other data or a predetermined scale or ranking) level of quality for the inputs 210. An assessment that the inputs are of poor quality may be used to inform users generating the input data to improve the quality (e.g., descriptiveness of the language, the specificity of the inputs, etc.) of the current or future inputs. In some embodiments, operation 225 may be executed automatically in response to preceding operation(s).

Module 230 is to categorize the textual inputs. In effect, module 230 operates to determine a category for each of the sentences of the inputs 220 based on, for example, a particular type of performance evaluation characteristic. In some embodiments, operation 225 may be executed automatically in response to preceding operation(s).

Module 235 operates to generate, based on the pre-processed input data (e.g., text) and the determined category for each sentence, a plurality of summary sentences reflective of the input data. These summary sentences might be generated to capture the objective aspects of the inputs 205 to the extent that the inputs were relevant to the employee's performance metrics. In some instances, the summary sentences may include more concise versions of the inputs 210, clearer versions of the inputs, use more descriptive and/or expressive language, and combinations thereof. In some embodiments, operation 225 may be executed automatically in response to preceding operation(s).

Module 235 may provide a record or other representation of the summary sentences to a post-process module 240. Post-process module 240 may include, for example, formatting conversions and other techniques for conditioning the plurality of generated summary sentences so that they can be included in a summarization 215. Some aspects of post-process 240 may relate to further processing operations, including but not limited to communication interfaces and protocols, messaging formats, and data storage specifications. In some embodiments, operation 225 may be executed automatically in response to preceding operation(s).

Summarization 215 may include, in some embodiments, an ordered (i.e., ranked) listing of the plurality of summary sentences. The ordered listing may be from most important or most positive to the least important or least positive, or vice versa. Other rankings and ordered listings may be implemented. In some embodiments, the generated summarization 215 may be used in a broader process, such as a discussion between an employee and their manager during an annual performance review meeting or other times.

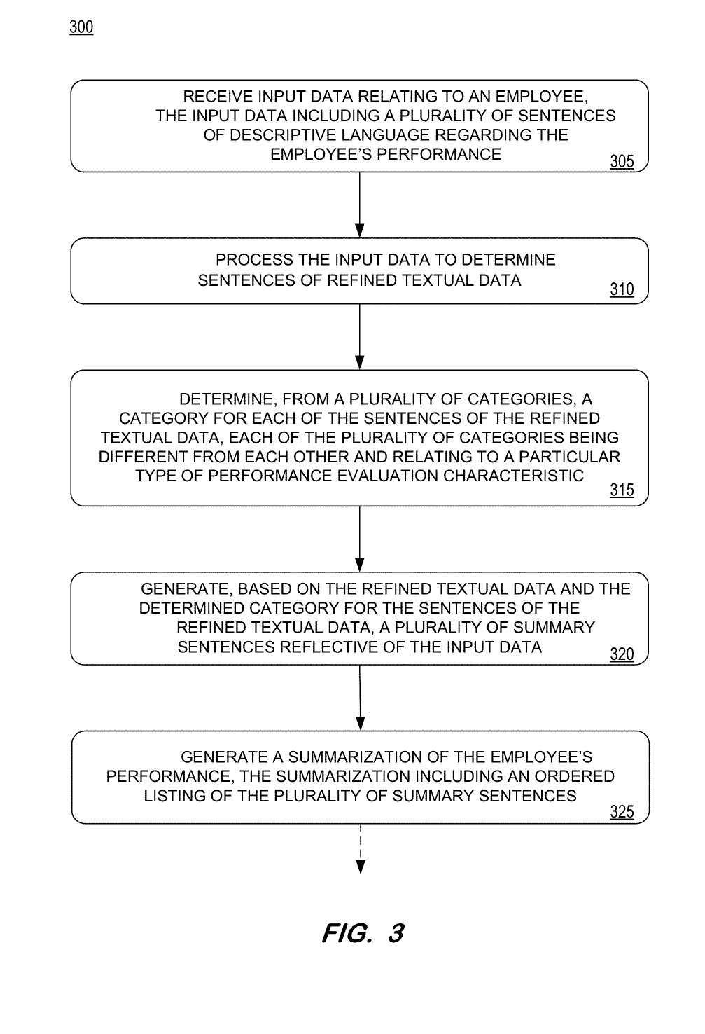

FIG. 3 is an example of a flow diagram of a process 300, in some embodiments herein. FIG. 3 includes a plurality of operations, operations that may comprise a portion of other processes. For example, operation 325 may interface with additional operations and processes, as indicated by the arrow shown in phantom in FIG. 3.

Operation 305 includes receiving input data relating to an employee, the input data including a plurality of sentences of descriptive language regarding the employee's performance. In general, the input data relates to an employee but need not be directly related to the employee's performance. For example, the input data may include statements about goals and/or objectives for an employee (specifically) or someone (generally) in their position within an organization, the organization, economic considerations (e.g., competitive environment, market performance, etc.), and other information. In some instances, the input data can be received from the subject employee themselves self-reporting on their own performance in their job and/or considerations and other stakeholder's regarding the employee's performance and the employee in general. The input data received at operation 305 may include textual data, as well as other types of data. In some embodiments, metadata related to an employee may be included in the input data. The metadata may include information regarding or somehow descriptive of the employee that can, in some instances, be used by process 300 to generate more accurate or otherwise improved and enhanced summarizations. In some regards, process 300 and other processes and systems disclosed herein, may generate better summarizations if users enter information throughout the year or otherwise continuously as events occur. In some instances, the data input into the systems and processes herein continuously may be accurate, detailed, and complete, at least in part since it is entered in a more timely basis. In part, a better summary may be determined and generated, at least in part, because all of the information need to generate an accurate summary has been entered and considered by the processes and systems disclosed herein.

Process 300 further includes operation 310 that processes the input data to determine sentences of refined textual data. As used herein, the refined text may include those input sentences determined to be relevant to and descriptive of the subject employee's performance. In writing and entering text statements that can be used as inputs to process 300, a user may enter statements, sentences, phrases, and the like that may be unfocused, tangential to the employee's performance, or otherwise not directed to the employee's performance. In some instances, the sentences may be unfocused based on the user being, for example, polite and/or hesitant to be critical of the employee's performance (either their own or other's).

Operation 315 includes determining, from a plurality of categories, a category for each of the sentences of the refined textual data, where each of the plurality of categories may be different from each other and relate to a particular type of performance evaluation characteristic. For example, there may be three different categories in one example embodiment. The three categories or buckets can include contributions that relate and refer to what the employee contributed throughout the evaluation period, a consider category that relates to areas and tasks the employee should consider to improve their performance, and a continue category that includes tasks and areas that the employee should continue to perform as they have currently or previously. In some embodiments, more or fewer categories may be used or considered. Operation 315 may operate to separate or otherwise designate the text-based sentences into one of the three categories.

In some instances, key words can be used to separate the sentences into the three categories, in the present example. In some embodiments, the key words can be generated or determined based on, at least in part, words historically used to describe each of the three different categories of “contributions”, “consider”, and “continue”. The input sentences, to the extent they are represented by the refined textual data from operation 310, may be examined for one or more of the key words related to the different categories.

Process 300 proceeds with operation 320 that can include generating, based on the refined textual data and the determined category for the sentences of the refined textual data, a plurality of summary sentences reflective of the textual input data. The summary sentences may then be used to generate a summarization of the employee's performance, where the summarization includes an ordered listing of the plurality of summary sentences in operation 325. Operation 325, as well as one or more of the other operations of process 300, may be executed automatically by a machine, system, apparatus, service, and combinations thereof.

Aspects of the processes, systems, and services discussed herein may be implemented through any tangible implementation of one or more of software, firmware, hardware, and combinations thereof.

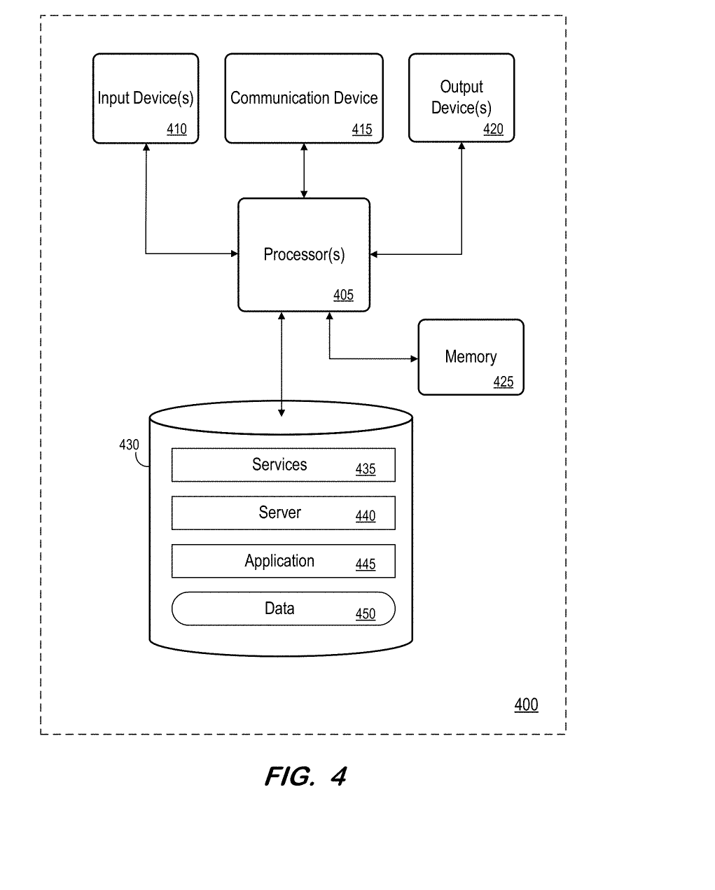

FIG. 4 is a block diagram of apparatus 400 according to one example of some embodiments. Apparatus 400 may comprise a computing apparatus and may execute program instructions to perform any of the functions described herein. Apparatus 400 may comprise an implementation of server 125, DBMS 135 and data store 130 of FIG. 1 in some embodiments. Apparatus 400 may include other unshown elements according to some embodiments.

Apparatus 400 includes processor 405 operatively coupled to communication device 415, data storage device 430, one or more input devices 410, one or more output devices 420 and memory 425. Communication device 415 may facilitate communication with external devices, such as a reporting client, or a data storage device. Input device(s) 410 may comprise, for example, a keyboard, a keypad, a mouse or other pointing device, a microphone, knob or a switch, an infra-red (IR) port, a docking station, and/or a touch screen. Input device(s) 410 may be used, for example, to enter information into apparatus 400. Output device(s) 420 may comprise, for example, a display (e.g., a display screen) a speaker, and/or a printer.

Data storage device 430 may comprise any appropriate persistent storage device, including combinations of magnetic storage devices (e.g., magnetic tape, hard disk drives and flash memory), solid state storages device, optical storage devices, Read Only Memory (ROM) devices, Random Access Memory (RAM), Storage Class Memory (SCM) or any other fast-access memory.

Services 435, server 440, and application 445 may comprise program instructions executed by processor 405 to cause apparatus 400 to perform any one or more of the processes described herein. Embodiments are not limited to execution of these processes by a single apparatus.

Data 450 (either cached or a full database) may be stored in volatile memory such as memory 425. Data storage device 430 may also store data and other program code for providing additional functionality and/or which are necessary for operation of apparatus 400, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program instructions stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

The embodiments described herein are solely for the purpose of illustration. Those in the art will recognize other embodiments which may be practiced with modifications and alterations.

What is claimed is:

1. A computer-implemented method of automatically summarizing employee performance, the method comprising:
receiving input data relating to an employee, the input data including a plurality of sentences of descriptive language regarding the employee's performance;
processing the input data to determine sentences of refined textual data;
determining, from a plurality of categories, a category for each of the sentences of the refined textual data, each of the plurality of categories being different from each other and relating to a particular type of performance evaluation characteristic;
generating, based on the refined textual data and the determined category for the sentences of the refined textual data, a plurality of summary sentences reflective of the input data; and
generating a summarization of the employee's performance, the summarization including an ordered listing of the plurality of summary sentences.

2. The method of claim 1, further comprising automatically determining, at least prior to the generating of the plurality of summary sentences, a quality evaluation of the input data.

3. The method of claim 1, wherein the input data relates to a performance of the employee, including textual input data generated by a plurality of entities.

4. The method of claim 3, wherein the plurality of entities includes at least one of the employee, a supervisor of the employee, a manager of the employee, a colleague of the employee, and a business consultant.

5. The method of claim 1, wherein the processing of the input data to determine the sentences of refined textual data comprises:
sorting textual data of the input data; and
transforming the sorted textual data into the sentences of refined textual data by pre-summarizing the textual input data.

6. The method of claim 1, wherein the plurality of categories of performance evaluation characteristics comprise, at least one or more of, a category to include contributions made by the employee, a category to include aspects to consider for improvement by the employee, and a category to include aspects the employee should continue.

7. The method of claim 1, wherein the determining of a category for each of the sentences of the refined textual data is based on a content of the sentences of the refined textual data.

8. The method of claim 7, wherein the determining of a category for each of the sentences of the refined textual data is further based on one or more keywords associated with each category, each keyword being associated with one of the plurality of categories based on historical employee performance data.

9. The method of claim 1, wherein the generating of the plurality of summary sentences includes:
determining whether each of the plurality of summary sentences are relevant to a performance review discussion; and
discarding sentences determined not to be relevant to the performance review discussion from the plurality of summary sentences.

10. The method of claim 1, wherein the generating of the summarization comprises:
determining a ranking, relative to each other, for each of the plurality of summary sentences; and
ordering the plurality of summary sentences in the ordered listing based on the determined ranking for each of the plurality of summary sentences.

11. The method of claim 1, wherein the input data further comprises metadata.

12. A system comprising:
a memory storing processor-executable instructions; and
a processor to execute the processor-executable instructions to cause the system to:
receive input data relating to an employee, the input data including a plurality of sentences of descriptive language regarding the employee's performance;
determine, from the input data, sentences of refined textual data;
determine, from a plurality of categories, a category for each of the sentences of the refined textual data, each of the plurality of categories being different from each other and relating to a particular type of performance evaluation characteristic;
generate, based on the refined textual data and the determined category for the sentences of the refined textual data, a plurality of summary sentences reflective of the input data; and
generate a summarization of the employee's performance, the summarization including an ordered listing of the plurality of summary sentences.

13. The system of claim 12, further comprising automatically determining, at least prior to the generating of the plurality of summary sentences, a quality evaluation of the input data.

14. The system of claim 12, wherein the input data relates to a performance of the employee, including textual input data generated by a plurality of entities.

15. The system of claim 14, wherein the plurality of entities includes at least one of the employee, a supervisor of the employee, a manager of the employee, a colleague of the employee, and a business consultant.

16. The system of claim 12, wherein the processing of the input data to determine the sentences of refined textual data comprises:
sorting textual data of the input data; and
transforming the sorted textual data into the sentences of refined textual data by pre-summarizing the textual input data.

17. The system of claim 12, wherein the plurality of categories of performance evaluation characteristics comprise, at least one or more of, a category to include contributions made by the employee, a category to include aspects to consider for improvement by the employee, and a category to include aspects the employee should continue.

18. The system of claim 12, wherein the determining of a category for each of the sentences of the refined textual data is based on a content of the sentences of the refined textual data.

19. The system of claim 18, wherein the determining of a category for each of the sentences of the refined textual data is further based on one or more keywords associated with each category, each keyword being associated with one of the plurality of categories based on historical employee performance data.

20. The system of claim 12, wherein the generating of the plurality of summary sentences includes:
determining whether each of the plurality of summary sentences are relevant to a performance review discussion; and
discarding sentences determined not to be relevant to the performance review discussion from the plurality of summary sentences.

21. The system of claim 12, wherein the generating of the summarization comprises:
determining a ranking, relative to each other, for each of the plurality of summary sentences; and
ordering the plurality of summary sentences in the ordered listing based on the determined ranking for each of the plurality of summary sentences.
